(19) United States
(12) Patent Application Publication
(10) Pub. No.: US 2010/0303974 A1
(43) Pub. Date: Dec. 2, 2010

(54) METHOD OF PREPARING AN EXTRACT FROM MULTIPLE BOTANIC HERBS BY AN ULTRASONIC WAY UNDER A LOW TEMPERATURE

(75) Inventor: Huan Wu, Taoyuan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: Sheng-Pu Pharmaceutic Co., Ltd, TAOYUAN COUNTY (TW)

(21) Appl. No.: 12/472,994

(22) Filed: May 27, 2009

(51) Int. Cl. A23L 1/025

(52) U.S. Cl. 426/238

(57) ABSTRACT

The present invention is related to a method of preparing an extract from multiple botanic herbs, which comprises immersing at least two botanic herbs into a solution to form a mixture, and extracting the mixture by an ultrasonic way under low temperature. The present invention provides higher efficiency of extraction than the conventional extraction method.

### FIELD OF THE INVENTION

This invention relates to a method of preparing an extract from multiple botanic herbs by an ultrasonic way under a low temperature.

### DESCRIPTION OF PRIOR ART

In the production of botanic herbs, extraction is an important step. Conventional methods of extracting final products from botanic herbs involves a time consuming, hazardous, energy inefficient, high temperature boiling and reduction process. The products from conventional methods of extraction contain higher concentrations of undesirable substances and lower concentrations of active compounds. Revolutionizing the extraction process of Chinese botanic herbal medicine is a challenge for the entire industry.

Many new methods of extraction techniques, such as microwave extraction, supercritical extraction, and high-pressure homogenous extraction, are currently under research but have not progressed beyond laboratory phases.

Microwave extraction uses microwave energy to react with the polar molecules in the material. The reaction generates a vast amount of heat energy causing increases in cell temperature and cell pressure, so as to cause breakage in the cell walls and diffuse the active components into the solution. Extracts are obtained by filtering and removing the remaining residues. Microwave extraction can be used for increasing efficiency in combination with conventional methods of extraction, such as soaking extraction, percolating extraction, and reflux extraction.

The microwave extraction, compared with the conventional methods, has the following advantages including: simple equipment, reagent saving, high repeatability, energy saving, low pollution, high extraction efficiency, and time saving. There are, however, some limitations for its widespread use on botanic herbs. For example, microwave extraction is only suitable for extraction of heat-stabilized substances. Secondly, the botanic herbs must have high water-absorbency, so as to absorb enough microwave energy to break the cell walls and release the active components. Furthermore, the cell wall breakage results in the unselective release of all components in the cell including undesirable possibly toxic compounds.

Supercritical fluid is a substance at temperatures and pressures above its critical point of gas and liquid state. The characteristics of Supercritical fluid are 1) highly dissolvable, 2) well transferable, 3) well flowing and 4) used to be as replacement for conventional poisonous, inflammable and volatile organic solvent. Compared with conventional methods, the advantages of supercritical fluid extraction are as follows: a) extracting the compound with different polar and boiling points near the room temperature, b) reserving the most of the active components, c) remaining no residue of organic solution, d) producing higher purity and higher yields (especially to materials having large molecular weight, high boiling point, or high heat sensitivity), and d) saving energy.

The supercritical fluid extraction also has its disadvantages to limit its widespread application. For example, additional regulators required to modulate the polarity of the supercritical fluids generally used during extraction can influence the sequential separation and analysis. Extracting the botanic herbs by utilizing the present method of supercritical fluid extraction is cost prohibitive due to the expensive procedures and equipments.

The aforementioned techniques are some of the most current technologies available for single botanic herb extraction but cannot be efficiently and synchronously applied to process and extract multiple botanic herbs simultaneously. An efficient method for extracting the active compounds from multiple botanic herbs simultaneously is in high demand.

### BRIEF DESCRIPTION OF THE DRAWINGS

FIG. 1 presents HPLC data of the extract obtained by using the method of the present invention. Examine the efficiency of extraction under different extraction times. (A) The extraction time is 30 minutes, (B) The extraction time is 45 minutes (C) The extraction time is 60 minutes. (For consistency, all three samples are analyzed by using the same HPLC)

FIG. 2 presents HPLC data with the conventional extraction method and the method of the present invention. Examine the extraction efficiency under different numbers of extractions. (A) The first extraction obtained by the conventional method was analyzed by HPLC. (B) The second extraction obtained by the conventional method was analyzed by the HPLC. (C) The first extraction obtained by the method of the present invention was analyzed by HPLC. (D) The second extraction obtained by the method of the present invention was analyzed by HPLC.

FIG. 3 presents HPLC data with the conventional extraction method and the method of the present invention. Examine and compare the extraction efficiencies between the present invention and the conventional extraction method. (A) Analyze the product combining the first with the second extracts obtained by the conventional extraction method (B) Analyze the product combining the first and the second extracts obtained by the method of the present invention.

### SUMMARY OF THE INVENTION

This invention provides a method of preparing an extract from multiple botanic herbs, which comprises immersing at least two botanic herbs into a solution to form a mixture, and extracting the mixture by an ultrasonic way under low temperature.

### DETAILED DESCRIPTION OF THE INVENTION

The present invention discloses that ultrasonic extraction increases the efficiency of extraction through violent vibrations and high speeds generated by ultrasonic waves. The present invention provides higher efficiency of extraction and is more time-saving compared to the conventional extraction method.

The method of the present invention for preparing an extract from botanic herbs comprises: immersing at least two botanic herbs into a solution to form a mixture and extracting the mixture by an ultrasonic way under low temperatures.

The present invention is applied to extract the botanic herbs simultaneously in the same vessel, which is similar to the conventional boiling method. There are previous protocols of extracting compounds from single botanic herb, for example, GB 2004197 and CN1857397. In these patents, the active compounds are extracted and purified from each botanic herb in separated vessels and combined to be the resulting extracts through the protocols. These protocols applied to extract and purify each botanic herb in separate vessels and combine the resulting extracts does not allow for any possible interaction between the different types of botanic herbs to occur. However, the present invention is applied to extract the active compound of botanic herbs simultaneously in the same vessel, which is more convenient and allows for any possible interactions between different botanic herbs and compounds during extraction. The types of botanic herbs consists of but are not limited to, Radix Ginseng, Ganoderma lucidum, Cordyceps sinensis, Codonopsis pilosula, Lycium barbarum, Ligustrum lucidum, Glycyrrhiza uralensis, Hedyotis diffusa, Agastache rugosus, and Prunella vulgaris, etc. The extracted parts of the botanic herbs comprise any or all parts of the plant, including but not limited to the root, leaf, fruit and/or stem.

The botanic herbs are grinded into small pieces approaching powder form before extraction. The grinding process increases the ultrasonic effect, promotes the extraction efficiency and lessens the extraction time. The botanic herbs also are dried at the temperature of 80° C. for 5 hours beforehand to facilitate the grinding process.

The extraction solution in the present invention is an organic solvent or water. The preferred solution of the present invention is water. The grinded botanic herbs are added to the solution in the ultrasonic instrument. The ratio of the extraction liquid to the botanic herbs is from 1:1 to 15:1 by weight. The preferred ratio of the present invention was 12:1. The stirring mechanism power in the ultrasonic instrument is switched on before adding the botanic herbs, so as to mix well the botanic herbs and solution. The stirring is proceeding at speeds between 500-2000 rpm/minute. The ultrasonic mechanism power in the ultrasonic instrument is switched on when the temperature inside the instrument achieves the predetermined temperature. The temperature of the present invention is much lower than the boiling temperature in the conventional extraction method. In U.S. Pat. No. 6,689,348, the extract requires 90-200° C. heating process before ultrasonic extraction. The present invention does not require the extra heating process. The method of the present invention provides the extraction method under temperatures of 25-60° C. Therefore, the process of the present invention is time saving and energy saving, so as to lower costs. In the preferred embodiment of the present invention, the temperature is 30-40° C.

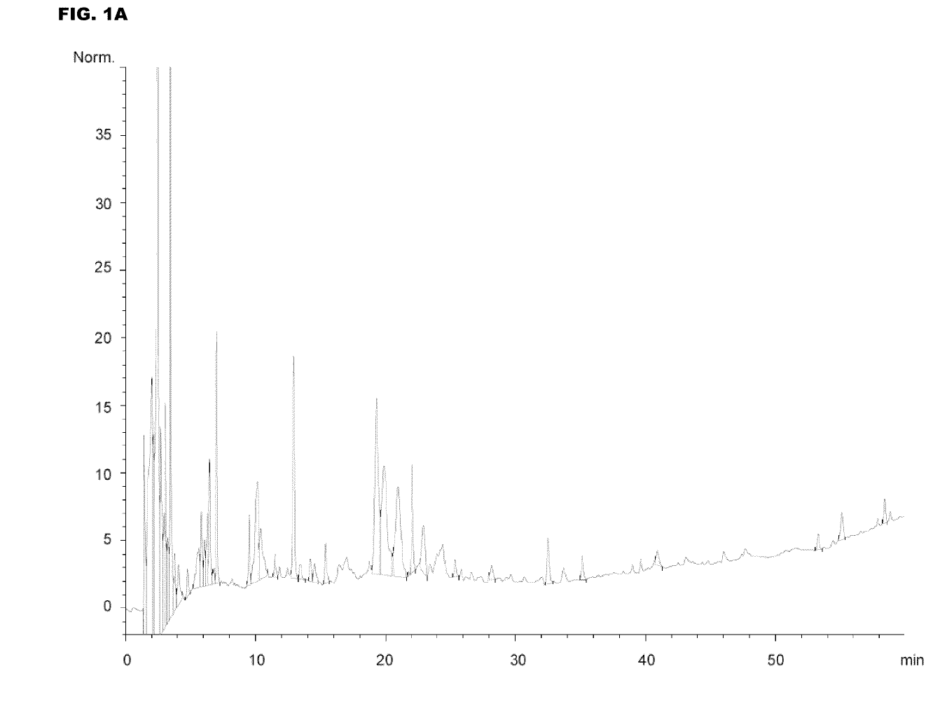

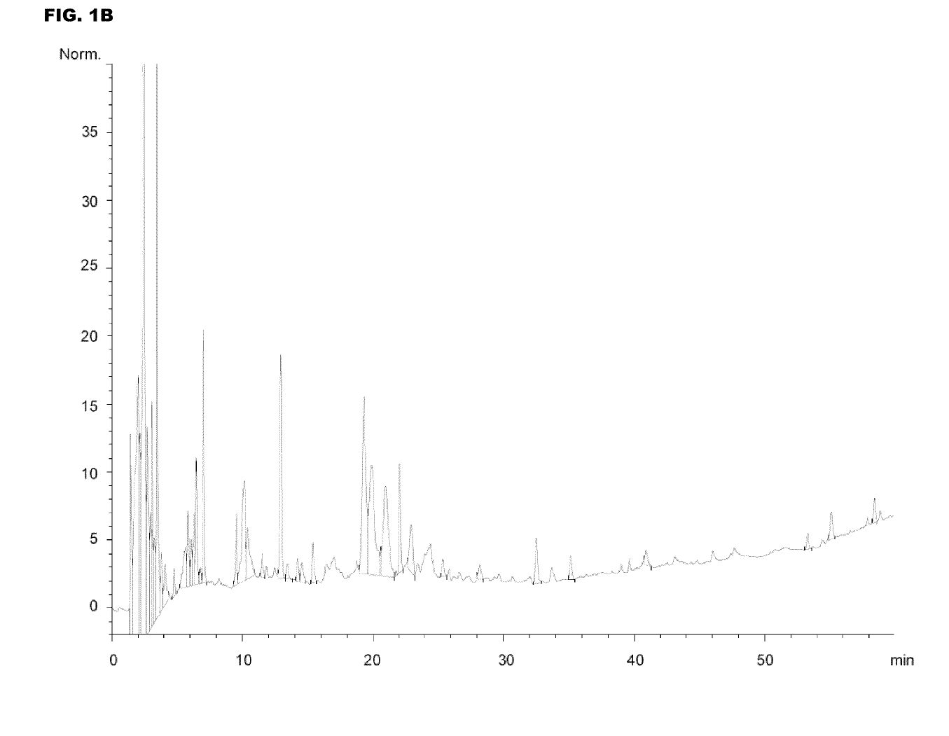

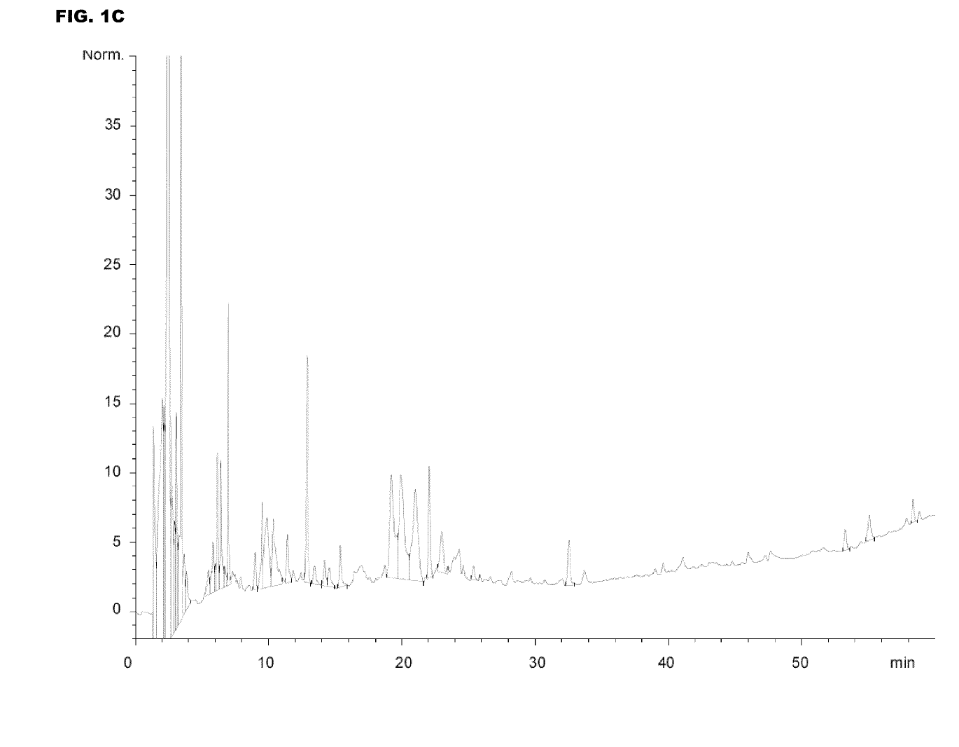

To examine the efficiencies of the different extraction times, 30, 40 and 60 minutes of extraction are performed. The extracts are collected and analyzed with High Performance Liquid Chromatography (HPLC). As shown in Table 1 and FIG. 1, the results indicate that 30-40 minutes of extraction is sufficient to extract the most of the active compounds. The extraction efficiency and performance does not increase by prolonging the extraction time. This result was inconsistent with conventional method of extraction in which extraction efficiency is proportional to extraction time.

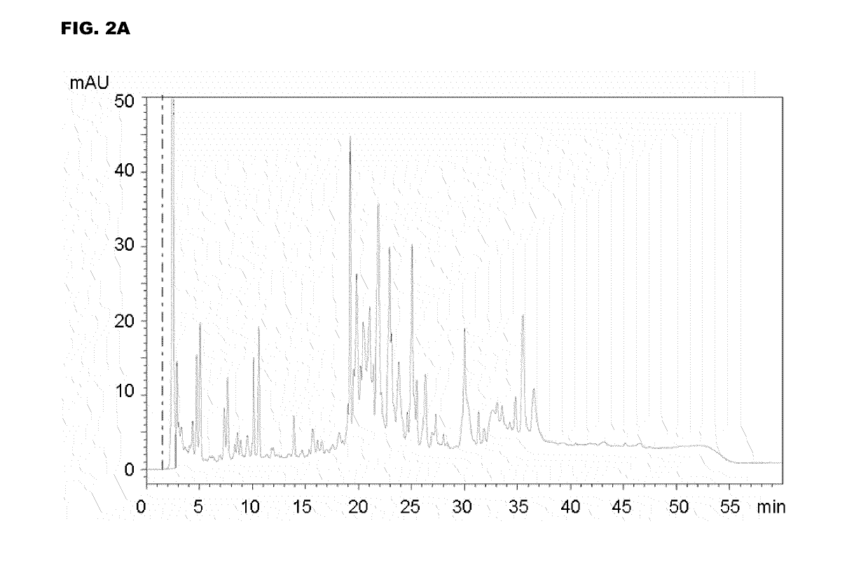

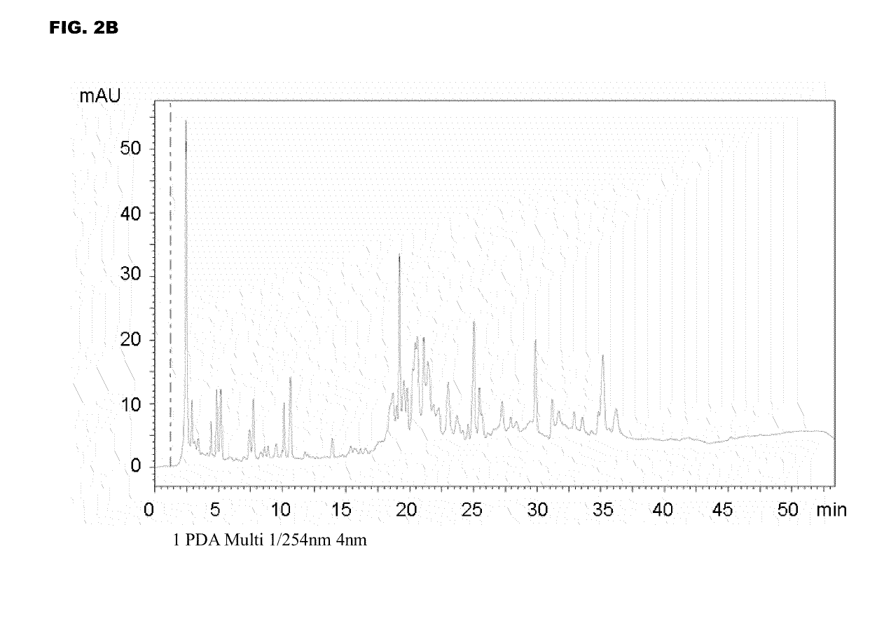

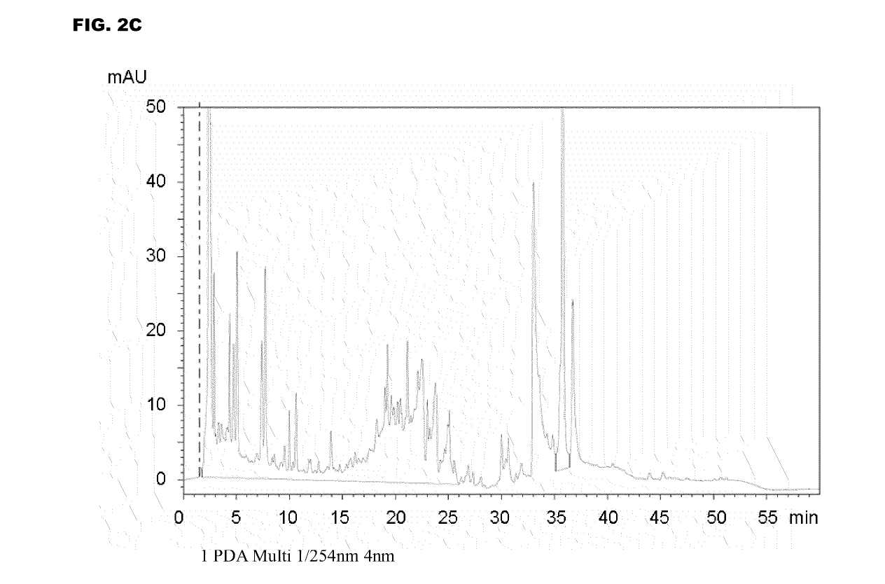

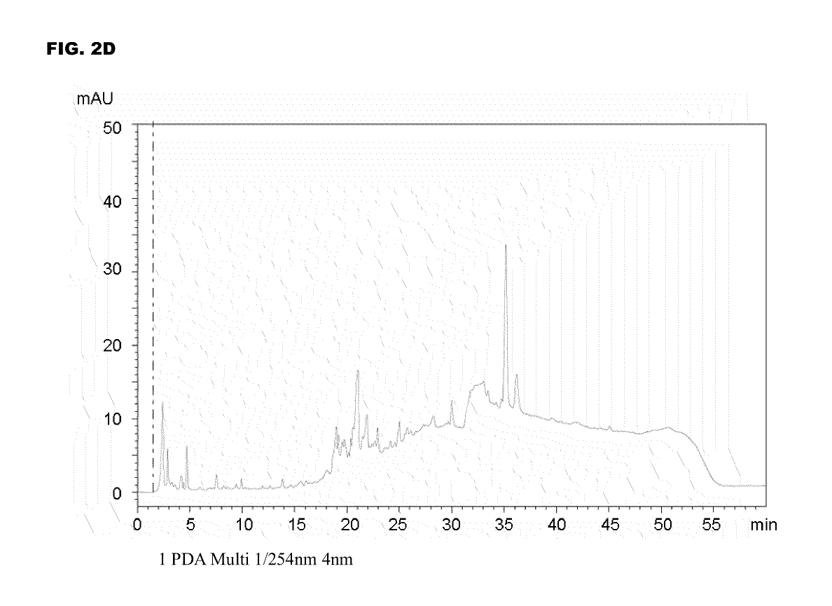

The conventional extraction method often comprises two or more extraction processes to obtain the highest amount of active compounds from the botanic herbs. In order to examine whether the ultrasonic extraction also requires two extraction processes, the botanic herbs are extracted twice and the extracts are then collected for HPLC analysis. The results indicate that about 75% of the compounds are extracted during the first extraction. Comparing the extraction efficiency between the present invention and the conventional method, the efficiency of the present invention is much higher than that of the conventional method. The results are depicted in Tables 4, 5, and FIG. 2.

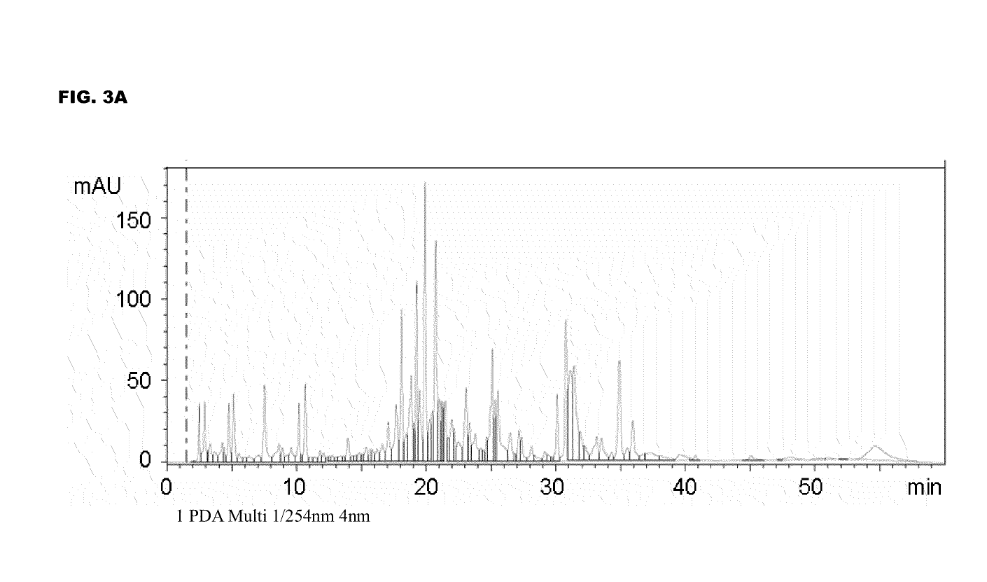

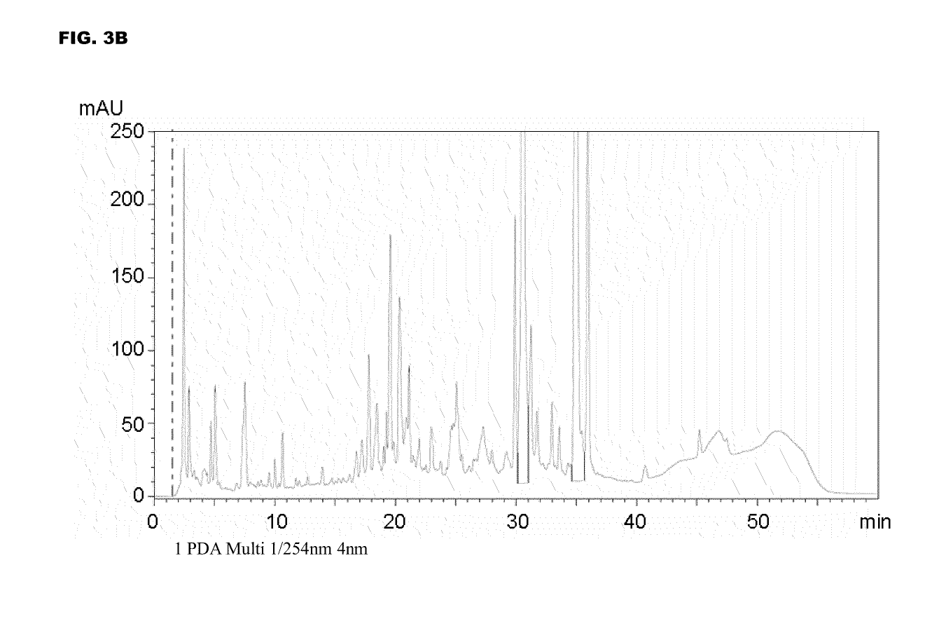

The extracts obtained from the different extraction methods are also examined. From each method, the conventional method and the present invention, products from the first and second extraction are combined, heated, boiled and filtered. The final products are then analyzed by HPLC. The results are shown in Tables 6 and FIG. 3. The major compounds are further analyzed in order to compare the differences between the conventional method and the method of extraction of the present invention. The results are shown in Tables 7, 8 and 9.

The ultrasonic conditions of the present invention are as follows: an ultrasonic frequency of 15-50 KHz, an ultrasonic power of 500-2000 W, 10-100 minutes of ultrasonification. In a preferred embodiment of the present invention, the ultrasonic frequency is 20 KHz, and the extraction by ultrasonication is performed for 30 minutes.

### EXAMPLE

The examples below are non-limiting and are merely representative of various aspects and features of the present invention.

### Example 1

### Examination of the Efficiency of Extraction Under Different Extraction Durations

Equipment Ultrasonic circulating extraction (HF-20B, HXL Biotechnol Developing Co., Ltd.)

Botanicals: Bupleuri Radix, Scutellariae Radix, Paeoniae alba Radix, Pinelliae Rhizoma, Zingiberis Recens Rhizoma, Aurantii Immaturus Fructus, Rhei Radix et Rhizoma, Abri herba, Desmodii styracifolii herba, Jujubae Fructus, and Corn Starch.

### Ultrasonic Condition

Botanical materials (g)/water (ml)=1:22 (1,000 g botanical materials with 22,000 ml pure water)

Staring temperature: 40° C.

Stirring speed: 1,200 rpm/minute

Ultrasonication: 4 seconds

Pause: 1 second

Total proceeding time of ultrasonication: 30, 45, 60 minutes

Ultrasonic power: 1800 W

Ultrasonic frequency: 20 KHz

Final temperature: 45° C.

### Sample Preparation

The botanic herbs were dried at 80° C. for 5 hours and ground into small pieces. After grinding, the botanic herbs were sieved with 8 mesh.

### Extraction

Appropriate amount of water was added into the ultrasonic instrument. Switched on the stirring mechanism and adjusted the speed to 1000-1200 rpm/min. After the sample preparation, the botanic herbs were added to the ultrasonic instrument. Then, the stirring speed was adjusted to 800-1000 rpm/min. The power of ultrasonication was switched on when the temperature achieved the desired temperature. The ultrasonication proceeded according to the ultrasonic condition described above.

### Experiment Design

In order to compare the extraction efficiency of different extraction times, the samples were divided into three groups. The extraction times of the different groups were distinctly 30, 45 and 60 minutes.

After extraction, the extracts were sequentially spinned for 15 minutes under 5000 rpm/min. The supernatant was filtered and the extracts of 1 g/22 mL were obtained. The extracts were further analyzed with High Performance Liquid Chromatography (HPLC). The results were shown in FIG. 1 and the raw data was shown in Table 1.

TABLE 1

| 30 min | | | 45 min | | | 60 min | | |
|---|---|---|---|---|---|---|---|---|
| Ret. time | Area | Height | Ret. time | Area | Height | Ret. time | Area | Height |
| 1.349 | 170.85909 | 22.12899 | 1.422 | 117.90233 | 16.92739 | 1.385 | 151.39632 | 17.66958 |
| 2.014 | 407.94757 | 16.65515 | 2.026 | 434.69772 | 20.15686 | 2.058 | 446.98782 | 18.42633 |
| 2.420 | 575.01746 | 103.96288 | 2.440 | 1137.61792 | 146.96027 | 2.425 | 1101.67700 | 119.56602 |
| 2.470 | 495.54675 | 95.64037 | 2.710 | 144.71065 | 15.39716 | 2.735 | 178.91898 | 15.82921 |
| 3.385 | 313.68732 | 70.25059 | 3.452 | 220.78746 | 43.02122 | 3.416 | 350.69540 | 73.40951 |
| 6.734 | 101.28466 | 14.99707 | 6.486 | 62.89432 | 9.33477 | 6.983 | 126.22433 | 20.39913 |
| 12.450 | 134.64362 | 14.77960 | 12.959 | 177.76495 | 16.42806 | 12.911 | 161.18169 | 16.36629 |
| 18.661 | 533.91992 | 27.29714 | 19.323 | 271.28235 | 13.05877 | 19.236 | 175.01207 | 7.45541 |
| 19.744 | 167.46483 | 5.91794 | 19.867 | 247.55867 | 8.07419 | 19.959 | 213.53716 | 7.53000 |
| 20.811 | 113.61392 | 4.70888 | 20.965 | 186.60339 | 6.68038 | 21.020 | 186.31018 | 6.57359 |
| Total Area | 4349.6973 | 507.18750 | | 4363.3994 | 439.93944 | | 4328.4213 | 429.64007 |
| Peak | 39 | | 41 | | | 37 | | |

The results showed that the extracts from different extraction durations had similar patterns in the HPLC figure (FIG. 1). The number of peaks, height of peak, area of peak, and the total area of the peaks were similar. The results indicated that the optimum efficiency was obtained at 30-40 minutes of the ultrasonic extraction. The efficiency of extraction was not increased by prolonging extraction time.

### Example 2

### Examination of extraction efficiency under different numbers of times of Repeated Extraction

Equipment: Ultrasonic circulating extraction (HF-20B, HXL Biotechnol Developing Co., Ltd.) and 4 L of stainless steel vessel with a temperature-regulating heater.

Botanic herbs: Bupleuri Radix, Scutellariae Radix, Paeoniae alba Radix, Pinelliae Rhizoma, Zingiberis Recens Rhizoma, Aurantii Immaturus Fructus, Rhei Radix et Rhizoma, Abri herba, Desmodii styracifolii herba, Jujubae Fructus, and Corn Starch.

### Ultrasonic Conditions

Botanic herbal material (g)/water (ml)=180 g botanic herbal materials/2200 mL pure water

Staring temperature: 40° C.

Stirring speed: 1100 rpm/minute

Ultrasonication: 3.5 seconds

Pause: 1.5 second

Total proceeding time of ultrasonication: 30 minutes

Ultrasonic power: 900 W

Ultrasonic frequency: 20 KHz

### Sample Preparation

The sample preparation was the same as Example one.

### Extraction

### Conventional Extraction Method

2200 mL of pure water was added into the 180 g of botanic herbs to obtain a mixture. Heated the mixture and kept the mixture boiled for 2 hours. During the process of boiling, added the appropriate amount of water for resupplying the loss of vapor. After boiling, the extracts were filtered and the first extract was obtained with a volume of 1070 mL. The rest of the botanic herbs were extracted for the second time by adding 2000 mL of pure water and boiling for 2 hours. The sequential procedure of the second extraction was the same as the first extraction. After filtering, the second extract was obtained with a volume of 950 mL.

Extract with Ultrasonic Instrument

The procedure was the same as Example 1. However, after obtaining the extract, added 2000 mL of pure water into the rest botanic herbs and proceeded to the extraction again to obtain the second extract.

To determine the difference between the efficiency of the extraction in the first extraction versus the second extraction, the extraction was performed twice. The extraction efficiency of different numbers of times of repeated extraction between the conventional extraction method and the method of the present invention was examined. Each method further was divided the two groups of samples by different number of extraction times.

After extraction of all groups, four extracts were analyzed with the HPLC. The results were shown in FIG. 2. The raw data was shown as Table 2 and Table 3.

TABLE 2

| The first extract was obtained from | | | The second extract was obtained from | | |
|---|---|---|---|---|---|
| the conventional extraction method | | | the conventional extraction method | | |
| Ret. Time | Area | Height | Ret. Time | Area | Height |
| 2.420 | 1048920 | 102667 | 2.444 | 549915 | 54121 |
| 2.870 | 110083 | 14348 | 2.898 | 88073 | 10129 |
| 4.734 | 139974 | 14950 | 4.852 | 99080 | 11475 |
| 10.598 | 154397 | 17724 | 10.626 | 110901 | 12708 |
| 19.201 | 342669 | 43651 | 19.198 | 285906 | 31481 |
| 19.820 | 387572 | 24162 | 19.805 | 118012 | 11220 |
| 20.434 | 391403 | 17567 | 20.423 | 199298 | 17358 |
| 21.070 | 434321 | 19483 | 21.098 | 282884 | 18016 |
| 21.848 | 642540 | 33203 | 21.875 | 132135 | 7340 |
| 22.931 | 458214 | 27409 | 23.043 | 265892 | 10824 |
| 23.796 | 321468 | 11795 | 23.712 | 141803 | 5436 |
| 25.047 | 435676 | 27454 | 25.017 | 270443 | 20138 |
| 30.004 | 416084 | 15970 | 29.866 | 235370 | 16587 |
| 35.506 | 376528 | 17241 | 33.162 | 254867 | 13422 |
| Total Area | 9377688 | 647953 | | 7270121 | 495783 |

| | | |
|---|---|---|
| Total peak | 84 | 86 |

TABLE 3

| The first extract was obtained from | | | The second extract was obtained from | | |
|---|---|---|---|---|---|
| the method of present invention | | | the method of present invention | | |
| Ret. Time | Area | Height | Ret. Time | Area | Height |
| 2.414 | 5812305 | 598093 | 2.389 | 176356 | 12156 |
| 2.864 | 113243 | 21423 | 2.867 | 58176 | 5746 |
| 4.348 | 101904 | 18487 | | | |
| 4.733 | 143720 | 14765 | 4.703 | 49350 | 5998 |
| 5.058 | 240049 | 27443 | | | |
| 7.694 | 271295 | 26792 | | | |
| 21.114 | 222879 | 18661 | 21.017 | 287684 | 12808 |
| 22.117 | 273844 | 14782 | | | |
| 22.492 | 406729 | 16373 | | | |
| 32.999 | 920020 | 39584 | | | |
| 35.760 | 1122312 | 67227 | 35.157 | 455961 | 23656 |
| 36.715 | 428004 | 22487 | | | |
| Total Area | 14976473 | 1228370 | | 3238601 | 191747 |

| | | |
|---|---|---|
| Total peak | 99 | 74 |

TABLE 4

| | | | | The total area when |
|---|---|---|---|---|
| | | | | the concentration is |
| Sample | Concentration | Peak | Total area | adjusted to 1 g/10 ml |
| 1 | 1.68 g/10 ml | 84 | 9377688 | 5581957 |
| 2 | 1.87 g/10 ml | 86 | 7270121 | 3887765 |

TABLE 5

| | | | | The total area when |
|---|---|---|---|---|
| | | | | the concentration is |
| Sample | Concentration | Peak | Total area | adjusted to 1 g/10 ml |
| 3 | 1.01 g/10 ml | 99 | 14976473 | 14828191 |
| 4 | 0.9 g/10 ml | 74 | 3238601 | 3598446 |

The result showed that when applying the method of the present invention, the second extraction produced about 24.26% of the first extraction. This result indicated that most of the ingredients in the botanic herbs had already been extracted from the botanic herbs by the first extraction.

To compare the different extraction methods, the concentrations of the samples were adjusted to 1 g/10 mL.

### Example 3

### Examination of Extraction Efficiencies of the Present Invention and the Conventional Extraction Method

Equipment Ultrasonic circulating extraction (HF-20B, HXL Biotechnol Developing Co., Ltd.)

Botanic herbs: Bupleuri Radix, Scutellariae Radix, Paeoniae alba Radix, Pinelliae Rhizoma, Zingiberis Recens Rhizoma, Aurantii Immaturus Fructus, Rhei Radix et Rhizoma, Abri herba, Desmodii styracifolii herba, Jujubae Fructus, and Corn Starch.

### Ultrasonic Condition

Botanic herbal material (g)/water (ml)=180 g botanic herbal materials/2200 mL pure water

Staring temperature: 40° C.

Stirring speed: 1100 rpm/minute

Ultrasonication: 3.5 seconds

Pause: 1.5 second

Total proceeding time of ultrasonication: 30 minutes

Ultrasonic power: 900 W

Ultrasonic frequency: 20 KHz

### Sample Preparation

The sample preparation is the same as Example 1.

### Extraction

### Conventional Extraction Method

2200 mL of pure water was added into the 180 g of botanic herbs to obtain a mixture. Heated the mixture and kept the mixture boiled for 2 hours. During the process of boiling, added appropriate amount of water for resupplying the loss of vapor. After boiling, the extracts were filtered and the first extract was obtained with a volume of 1070 mL. The rest of the botanic herbs were extracted for the second time by adding 2000 mL of pure water and boiling for 2 hours. The sequential procedure of the second extraction was the same as the first extraction. After filtering, the second extract was obtained with a volume of 950 mL.

Extract with Ultrasonic Instrument The procedure was the same as Example 1. After obtaining the extract, added 2000 mL of pure water to the rest of the botanic herbs and repeated the extraction to obtain the second extract.

From the results of Example 3, there were differences between the different extraction methods in the major peaks. The major peaks of the conventional method appeared around 18-26 minutes. However, the major peaks of the present invention appeared around 2-7 minutes and 31-36 minutes. In order to determine if the difference between the major peaks was a result of the extraction process, the heating, boiling, and concentrating processes were applied to all extracts from all groups. The extracts were heated and condensed to 650 mL. The concentrations were 2.769 g/mL. The extracts further centrifuged and filtered were analyzed with HPLC. The results were shown as FIG. 3 and Table 6.

TABLE 6

| The extracts obtained from the | | | The extract obtained from the | | |
|---|---|---|---|---|---|
| conventional method | | | method of the present invention | | |
| Ret. Time | Area | Height | Ret. Time | Area | Height |
| 2.462 | 181413 | 36021 | 2.471 | 2247381 | 238379 |
| 2.870 | 379313 | 37188 | 2.869 | 748201 | 74820 |
| 5.118 | 436667 | 41958 | 5.037 | 761401 | 74948 |
| 7.507 | 611227 | 47079 | 7.508 | 1391831 | 76472 |
| 17.674 | 566363 | 34854 | 17.792 | 1344435 | 91771 |
| 18.081 | 955942 | 93326 | | | |
| 18.826 | 837335 | 52844 | 18.441 | 1171506 | 58198 |
| 19.236 | 853818 | 110619 | 19.235 | 458399 | 52927 |
| 19.450 | 576351 | 438993 | | | |
| 19.880 | 1703127 | 171676 | 19.561 | 2305618 | 173610 |
| 20.253 | 337703 | 25886 | 20.341 | 2485629 | 130767 |
| 20.706 | 1512845 | 135281 | | | |
| 21.145 | 296117 | 37221 | 21.126 | 867680 | 83783 |
| 23.072 | 667051 | 44865 | | | |
| 25.086 | 937188 | 68973 | 25.056 | 1423834 | 70834 |
| 25.516 | 817498 | 43632 | | | |
| 30.086 | 425202 | 41081 | 29.904 | 1966740 | 183410 |
| 30.772 | 1172184 | 87039 | 30.516 | 18235791 | 1259892 |
| 31.137 | 996114 | 55384 | 31.208 | 1743674 | 107788 |
| 31.389 | 1167160 | 58465 | | | |
| 34.881 | 931874 | 61643 | 34.897 | 13362993 | 856493 |
| | | | 35.924 | 3680180 | 274022 |
| Total area | 29707794 | 2255076 | | 76775075 | 5088474 |
| Peak | 105 | | 97 | | |
| Comparison | 100% | 100% | | 258.43% | 225.64% |
| of total area | | | | | |

The major peaks around 18-26 minutes of the present invention had increased. The result indicated that the peaks resulted from the extraction under high temperature. If the desired products were unhydrolyzed compounds by high temperature or the original compounds, the extraction process was under low temperature or applied with freeze-drying condensation. On the contrary, if the desired compounds were hydrolyzed products under high temperature or the new compounds produced during the extraction process, additional condensation under high temperature is applied after ultrasonic extraction.

Compared the Concentration of Extracts from the Different Extraction Methods with Industry Standards

The compounds in the extracts were further examined with HPLC.

### HPLC Assay Condition:

5 mg of respective industry standard with concentration adjusted to 0.2 mg/l ml with 25 mL of methanol.

### 1. HPLC: Agilent 1200 Series HPLC

2. Mobile phase: acetonitrile:water=35:65

### 3. Column: Cosmosil 5C₁₈-AR-II, Size: 4.6 I.D.×250 mm

4. Rate: 1 mL/min

### 5. Wavelength: 210 nm

6. Temperature: room temperature

### 7. Injection: 20 μL

The results of Saikosapon α were shown as Table 7 and the results of Paeoniflorin were shown as Table 8 and the results of Emodine were shown as Table 9.

Compared the Amount of Saikosaponin α from the Different Extraction Methods

The Saikosaponin α in extracts obtained from different extraction methods were compared. The results were shown as Table 7.

TABLE 7

| | Concentration | Comparison (the ratio |
|---|---|---|
| Sample | (μg/ml) | with conventional method) |
| Standard of | 200 | |
| Saikosaponin α | | |
| Conventional method | 6.846781 | 1 |
| The present invention | 33.23877 | 4.85 |

Compared the Amount of Paeoniflorin from the Different Extraction Methods

### HPLC Assay Condition:

Mobile phase: methanol and water

| Min | MeOH % | Water |
|---|---|---|
| 0 | 0 | 100 |
| 10 | 20 | 80 |
| 20 | 40 | 60 |
| 30 | 50 | 50 |
| 40 | 70 | 30 |
| 50 | 80 | 20 |
| 60 | 100 | 0 |

Wavelength: 230 nm

Injection: 10 μL.

TABLE 8

| | Concentration | Comparison (the ratio |
|---|---|---|
| Sample | (μg/ml) | with conventional method) |
| Standard of | 200 | |
| Paeoniflorin | | |
| Conventional method | 27.489148 | 1 |
| The present invention | 42.490146 | 1.55 |

Compared the Amount of Emodin from the Different Extraction Methods

### HPLC Assay Condition:

Mobile phase: methanol:0.1% phosphoric acid=85:15 Wavelength: 254 nm

Injection: 20 μL.

TABLE 9

| | Concentration | Comparison (the ratio |
|---|---|---|
| Sample | (μg/ml) | with conventional method) |
| Standard of emodin | 200 | |
| Conventional method | 7.561365 | 1 |
| The present invention | 5.085033 | 0.67 |

The emodin was the result of hydrolyzation under high temperatures. Therefore, the amount of emodin produced by the conventional extraction method was more than those produced by the present invention.

While the invention has been described and exemplified in sufficient detail for those skilled in this art to utilize, various alternatives, modifications, and improvements should be apparent without departing from the spirit and scope of the invention.

One skilled in the art readily appreciates that the present invention is well adapted to obtain the results and advantages mentioned, as well as those inherent therein. Modifications therein and other uses will occur to those skilled in the art. These modifications are encompassed within the spirit of the invention and are defined by the scope of the claims.

What is claimed is:

1. A method of preparing an extract from multiple botanic herbs, comprising:
(a) immersing at least two botanic herbs into a solution to form a mixture; and
(b) extracting the mixture by an ultrasonic way under a low temperature.

2. The method according to claim 1, wherein the extract consists of multiple active components.

3. The method according to claim 1, which further comprises grinding the botanic herbs before the step of (a).

4. The method according to claim 3, which further comprises drying the botanic herbs before grinding.

5. The method according to claim 3, which further comprises sieving the botanic herbs after grinding.

6. The method according to claim 5, wherein said sieving is by 2-12 mesh.

7. The method according to claim 1, wherein the solution is organic solution or water.

8. The method according to claim 7, wherein the organic solution is methanol, ethanol, acetic ether, ketone, hexane, propanol, isopropanol or chloroform.

9. The method according to claim 7, wherein the solution is water.

10. The method according to claim 1, wherein ratio of the extraction liquid to the botanic herbs is 1:1 to 15:1 by weight.

11. The method according to claim 1, wherein the botanic herbs in the step of (b) is stirred during extraction.

12. The method according to claim 11, wherein the stirring is proceed under a speed of 500-2000 rpm/minute.

13. The method according to claim 1, wherein the step of (b) is processed under ultrasonic frequency of 15-50 KHz.

14. The method according to claim 13, wherein the step of (b) is processed under an ultrasonic frequency of 20 KHz.

15. The method according to claim 1, wherein the step of (b) is processed under an ultrasonic power of 500-2000 W.

16. The method according to claim 1, wherein the extraction in the step of (b) proceeds 10-100 minutes of ultrasonic treatment.

17. The method according to claim 1, wherein the temperature is 25° C.-60° C.

18. The method according to claim 17, wherein the temperature is 30-40° C.

19. The method according to claim 1, wherein the botanic herbs are selected from the group consisting of Bupleuri Radix, Scutellariae Radix, Paeoniae alba Radix, Pinelliae Rhizoma, Zingiberis Recens Rhizoma, Aurantii Immaturus Fructus, Rhei Radix et Rhizoma, Abri herba, Desmodii styracifolii herba, Jujubae Fructus, and Corn Starch.
